(19) United States
(12) Patent Application Publication
(10) Pub. No.: US 2005/0251632 A1
(43) Pub. Date: Nov. 10, 2005

(54) SILICON STORAGE MEDIA, CONTROLLER AND ACCESS METHOD THEREOF

(76) Inventor: Hsiang-An Hsieh, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/905,356

(22) Filed: Dec. 29, 2004

(30) Foreign Application Priority Data
May 6, 2004 (TW) 93112721

(51) Int. Cl. G06F 12/00

(52) U.S. Cl. 711/154

(57) ABSTRACT

The present invention provides a silicon storage media, a controller and an access method thereof. The silicon storage media includes a memory module and a controller. A block is designated as a basic erase/write/save unit in the memory module. The controller includes a system interface electrically coupled to the computer system, a memory interface electrically coupled to the memory module, a data buffer for buffering data, and a data compression/decompression module electrically coupled to the data buffer via a bi-directional bus for compressing/decompressing data stored in the data buffer. Wherein, the data transmitted from the computer system to the data buffer is compressed to a data frame and one block of the memory module serves to save merely the data of one data frame.

### CROSS-REFERENCE TO RELATED APPLICATION

This application claims the priority benefit of Taiwan application serial no. 93112721, filed May 6, 2004.

### BACKGROUND OF THE INVENTION

1. Field of the Invention

The present invention relates to a silicon storage media, and more particularly, to a variable length data frame based silicon storage media, a controller, and an access method thereof.

2. Description of Related Art

It is common to use a memory made of silicon chip as a silicon storage media in the present time. Most of the silicon storage media are connected to a system interface via a controller in order to write information into memory or read information from memory and transmit information to the system. Wherein, since it is characterized by its low power consumption, high reliability, high capacity, fast data access rate, the silicon storage media had been widely used in various portable digital electronic apparatus, such as the products of digital camera, digital walkman, personal digital assistant (PDA), its business is growing rapidly. Many types of the silicon storage media are derived from the original silicon storage media, including: Compact Flash Card (CF), Memory Stick Card (MS), Secure Digital Card (SD), Smart Media Card (SM), etc. In addition, when it is applied in the personal computer, the USB portable disk using the Universal Serial Bus (USB) has become a very popular product in recent year.

The storage capacity of various portable storage apparatus which are used as the silicon storage media and are made of the silicon chip memory mentioned above are limited by the capacity of its embedded memory. The controller inside the portable storage apparatus only has one interface, which is connected to a system for receiving an instruction from the system and accessing the content in the memory according to the received instruction. Therefore, the major portion of the portable storage apparatus cost is the cost of the memory chip. In order to reduce the manufacture cost, a major subject is how to fully utilize the limited capacity of the memory.

A conventional memory allocation method is described hereinafter. In the prior art, data is mainly processed in a unit of a single sector, and a page is mainly designated as a basic storage unit of the silicon storage media. Wherein, the size of one sector is 512 bytes, and the size of one single page is depended on the silicon storage media. A 64 MB NAND type flash memory 100 shown in FIG. 1A is composed of 4096 blocks indicated by the reference number 104, and each block 104 is composed of 32 pages. In addition, each page is composed of 512 bytes data area +16 bytes redundant area constituting a total size of 528 bytes. A 128 MB NAND type flash memory 106 shown in FIG. 1B is composed of 1024 blocks equaling to 64 pages. In such case, the size of each page is 2048 bytes data area +64 bytes redundant area constituting a total size of 2112 bytes.

A single page is designated as a basic access (read/write) unit of the silicon storage media. However, in order to accurately record information, an erase operation is performed on the silicon storage media first in order to erase the page contents before writing the information, such that the written information can be accurately preserved. In addition, the time required for performing the erase operation is longer than the time required for performing the access operation. Since the circuitry required for controlling the erase operation is very complicated, in order to reduce the manufacture cost, it is a general approach that the silicon storage media intends to improve the unit capacity impacted by the erase operation. For example, 32 pages are combined into a single block, such that the erase operation can only impact the continuous capacity space of a single block in one time so as to reduce the quantity of the required circuitries installed in the silicon storage media and to achieve the object of reducing the manufacture cost.

In summary, the main characteristics of the silicon storage media are as follows. (a). The unit capacity of the access operation is different from the unit capacity of the erase operation. The access operation is mainly processed in a unit of pages, and the erase operation is mainly processed in a unit of blocks. However, it is common that a single block may comprise a couple of continuous pages. (b). The time required for performing these two operations are not the same. The time required for performing the erase operation is longer than the time required for performing the access operation. (c). It has to make sure the page to be read is erased and empty before the write operation is performed, such that the written data can be accurately recorded in the silicon storage media. The silicon storage media controller makes good use of the characteristics mentioned above, so as to avoid performing the erase operation on whole block even only one or two pages are required to write during the write operation, which causes longer operation time and also deteriorates access performance. With such method, the record space of the silicon storage media can be fully utilized.

FIG. 2A is a schematic block diagram illustrating an internal structure of a conventional silicon storage media 200. The conventional silicon storage media 200 is mainly composed of a silicon storage media controller 210 and more than one memory 220. A microprocessor 213 is installed inside the silicon storage media controller 210 for transmitting and receiving instruction and data to/from an external computer system (not shown) via a system interface 211. After the data is stored in a data buffer 215, the data is written into the memory 220 via a memory interface 217. On the other hand, after the data is read from the memory 220 and temporarily stored in the data buffer 215, the data is sent back to the computer system which requests to read data via the system interface 211.

It is known from the description mentioned above that the characteristics of the configuration and the data record structure of the conventional silicon storage media controller are as follows. (a). The original data is directly stored into a designated address in the silicon storage media without any compression. (b). A page is designated as a basic access (read/write) unit, and the control information such as the index indicator and the error check and correction code are marked in each page's reserved redundant area. After all required control information is stored, it is common that some non-used reserved space still left in the control information record area. Although the capacity of the non-used space is not so significant with respect to each page size, it is really a waste of resource to some extent when all redundant areas are accumulated.

In addition, in order to improve the data storage capacity of the memory module, a compression function (or a module) may be furthered installed inside the controller. However, since a sector of 512 bytes is not big enough, the compression performance is not impressive.

In summary, in the silicon storage media mentioned above, since a page is designated as an access unit, the controller performance cannot be fully deployed. If an erased block is designated as a basic access unit in cooperated with the technique of the data compression unit and data decompression unit which are installed inside or outside of the controller, the storage capacity of the memory card can be improved even under the condition of not installing additional hardware component for the silicon storage media. In addition, with such method, the performance is improved, the redundant area in each page is fully utilized, and the compression performance is further improved.

### SUMMARY OF THE INVENTION

Therefore, the present invention is directed to a silicon storage media for reducing wasting of the redundant area and for effectively improving the data update and compression performance, a controller, and an access method thereof.

The present invention is directed to a silicon storage media controller. Wherein, a variable length data frame is designated as a basic operation unit for the block, such that the silicon storage media controller can fully utilizes its computing power and can make good use of the limited capacity of the memory. In the present invention, when the system intends to write the data into the portable storage device, the data content is compressed inside or outside of the controller first, and then recorded into the memory. On the other hand, when the system intends to read the data, the previously compressed data is read from the memory into the controller first, and the data is then sent back to the system after it is decompressed. The original data is compressed into a corresponding data by a compression module and a corresponding decompression module provided by a compression mechanism, such that the storing performance of the memory is significantly improved due to the fact that the amount of the data access between the external system and the memory had been significantly reduced.

The present invention is directed to a silicon storage media where a block with a large capacity is designated as a basic operation unit, a controller and an access method thereof. An optimal compression/decompression mechanism is obtained from the combination of a plurality of algorithms and parameters built in the controller. In addition, the efficiency and the compression rate of the data compression/decompression are improved by increasing the capacity of a basic controlled unit, and the data amount of the external data is used as a micro data optimal to the block, such that the utilization of the record space is further improved.

The present invention is also directed to a silicon storage media where the block mentioned above is designated as a basic operation unit, a controller and an access method thereof. Accordingly, the computer system can write a plurality of sectors data in one time, compress and write the data into the memory in one time only when the amount of the data temporarily stored in the silicon storage media accumulated is equal to a storage capacity of one block, such that the computer system can avoid wasting too much time in waiting for the writing. In addition, a whole block can be erased and written later when it is being updated, thus the problem of erasing the whole data area in order to write only one or two pages data is no longer required.

According to an embodiment of the present invention, a silicon storage media controller suitable for the silicon storage media comprising a memory module and where a block is designated as an erase unit of the memory module is provided. The silicon storage media controller comprises a system interface, a memory interface, a data buffer and a data compression/decompression module. The system interface is electrically coupled to a computer system, the memory interface is electrically coupled to the memory module, the data buffer is electrically coupled to the system interface and the memory interface, and the data compression/decompression module is electrically coupled to the data buffer via a bi-directional bus for compressing/decompressing the data stored in the data buffer. Wherein, the data transmitted from the computer system via the system interface is compressed into a data frame whose size is suitable for the block storage capacity, and the data frame is then stored into the memory module.

The present invention further provides a method of writing data into the silicon storage media suitable for the silicon storage media where a block is designated as an erase unit. The writing method comprises following steps. The original data is compressed to a compressed data before it is stored into the silicon storage media first, and then a preceding description unit including a range of the original data is inserted in front of the compressed data in order to generate a data frame. Finally, the data frame is stored into the silicon storage media. In the case where the original data is already stored in the silicon storage media, a data frame corresponding to the original data is read from the silicon storage media first, and then the data obtained by decompressing the data frame is updated according to the original data, and the updated data is converted into a data frame format complied with the block storage capacity mentioned above and is finally stored in the silicon storage media.

In an embodiment of the present invention, in order to increase data reliability, an error check and correction code is further added at the end of the data frame. The preceding description unit further comprises a plurality of algorithms and parameters used for compressing the original data and a status of the block where the data is stored. In addition, the range of the original data mentioned above is represented by a start address and a length of the original data.

The present invention further provides a method of reading data from the silicon storage media suitable for the silicon storage media where a block is designated as an erase and write unit, wherein each block in the silicon storage media only has one data frame. The data frame comprises a preceding description unit for indicating a range of a non-compressed original data. The reading method comprises following steps. A data frame is read from the silicon storage media first, then the data frame is decompressed according to the preceding description unit, and finally the original data obtained by decompressing the data frame is output from the silicon storage media.

The present invention further provides a silicon storage media. The silicon storage media comprises a memory module and a controller, and is operated by the controller and the access method mentioned above.

In an embodiment of the present invention, the data compression/decompression module inside the controller of the silicon storage media mentioned above comprises a data compression circuitry, a data decompression circuitry, a compression algorithm description unit, and a parameter table. Wherein, the compression algorithm description unit is electrically coupled to the data compression circuitry and the data decompression circuitry respectively for storing the corresponding compression algorithm, which is used by the data compression circuitry and data decompression circuitry to compress/decompress data. In addition, the parameter table is electrically coupled to the data compression circuitry and the data decompression circuitry respectively for storing the parameters, which are used by the compression algorithm. Wherein, during the write operation, the data compression circuitry records the compression algorithm and the parameters used for compressing data in front of the data frame.

The present invention modifies the original control mode where a page is designated as an access unit. Instead, a block with a large capacity is designated as a basic control unit. In addition, the efficiency and the compression rate of the data compression/decompression are improved by increasing the capacity of a basic controlled unit, such that the utilization of the record space is further improved. In addition, since the original data has different characteristics, the compression rate of the data compression algorithm for each original data is not the same. Based on the characteristics mentioned above, the present invention configures the capacity of the compressed data, which is roughly equal to the size of one block unit, as a basic controlled unit. The present invention further comprises following steps: compressing the original data of different lengths; adding a preceding description unit in front of the compressed data; indicating information related to the block status, original data address corresponding to the compressed data, original data length, optimal algorithm, optimal parameter table, etc.; adding a post error check and correction code behind the compressed data; recording the error check and correction code corresponding to the compressed data; and combining the preceding description unit, the compressed data, the post error check and correction code mentioned above to form a data frame which is merely recorded in one single block. Since only one set of control information (including the preceding description unit and the error check and correction code, etc.) is recorded in a block, the memory capacity used in the conventional redundant area is significantly reduced, such that the manufacture cost is reduced.

Therefore, under the premise of maintaining the same memory capacity, by adding the data compression/decompression function into the controller of the portable storage device made of the improved silicon storage media, following objects can be achieved:
a. To improve storage capacity: under the condition of using the same size of the memory, the data is compressed before it is stored into the memory, thus more data can be stored in the portable storage media and the object of improving the storage capacity is achieved.
b. To reduce manufacture cost: comparing to the same size of the portable storage media, since the controller supports data compression/decompression function, a memory with a smaller capacity can be used, such that the object of reducing the manufacture cost is achieved.
c. To improve data access rate: the flash memory used in the current portable silicon storage media requires a special process when it is feeding data, which becomes a bottleneck of data access in system. In the present invention, the data transmitted by the system is compressed inside the controller before it is stored into the memory, thus the data amount of the memory to be accessed is reduced and the object of improving the data access rate is achieved.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1A is a schematic diagram for illustrating a record space of a 64 MB NAND type flash memory.

FIG. 1B is a schematic diagram for illustrating a record space of a 128 MB NAND type flash memory.

FIG. 2A is a schematic diagram for illustrating an internal structure of a conventional silicon storage media.

FIG. 2B is a schematic diagram for illustrating a block format of a NAND type flash memory.

FIG. 3A is a schematic diagram for illustrating a conventional silicon storage media controller with data compression function.

FIG. 3B is a schematic diagram for illustrating a silicon storage media controller with data compression function according to an embodiment of the present invention.

FIG. 4 is a schematic diagram of a block format according to an embodiment of the present invention.

FIG. 5A is a schematic diagram for illustrating a silicon storage media controller when the system is writing data according to an embodiment of the present invention.

FIG. 5B is a schematic diagram for illustrating a silicon storage media controller when the system is updating data according to an embodiment of the present invention.

FIG. 5C is a schematic diagram for illustrating a silicon storage media controller when the system is reading data according to an embodiment of the present invention.

FIG. 6 is a flow chart for illustrating a controlling process of a silicon storage media controller according to an embodiment of the present invention.

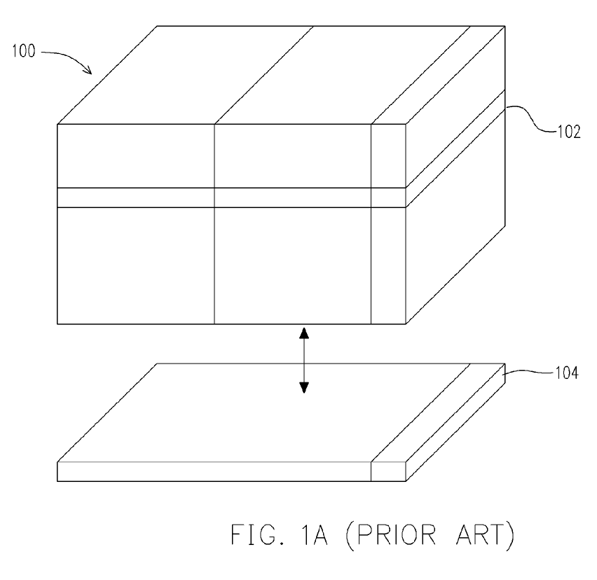

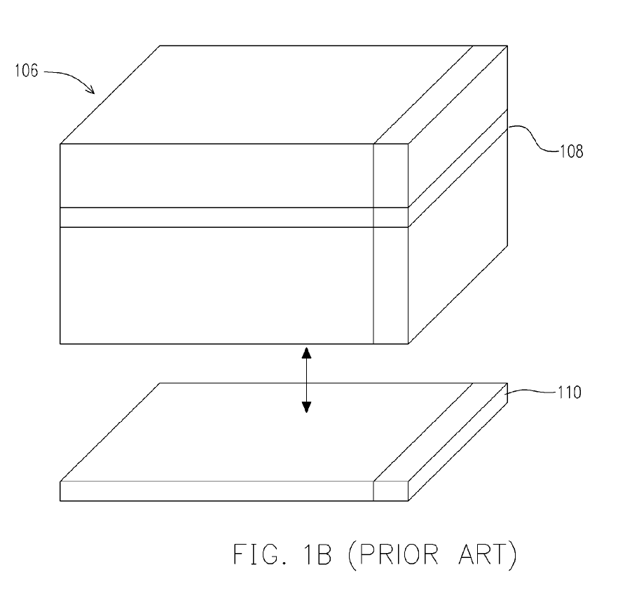

### DESCRIPTION OF EMBODIMENTS

The present invention provides a silicon storage media and a controller thereof, wherein a variable length data frame whose size is complied with the block storage size is designated as a basic record unit for the memory. In addition, a plurality of description units for various algorithms is introduced in the data compression/decompression module inside the controller for defining different types of the data compression/decompression algorithm, and an optimal compression algorithm is cooperated with various kinds of the parameter table. The object of installing various kinds of the algorithm and parameter table in the data compression/decompression module is to select a compression algorithm with optimal compression effect and to cooperate with an optimal parameter table. The controller marks and adds the compression algorithm, a parameter table indicator, and an index indicator corresponding to the original data in front of the compressed data, so as to form a preceding description unit. The controller marks and adds a post error check and correction code behind the compressed data for determining whether the compressed data is accurately recorded in the storage media or not. After a data frame is formed by combining the preceding description unit, the compressed data, and the post error check and correction code, the data frame is then stored and recorded into a designated block location in the silicon storage media. In the present invention, since a data frame corresponding to the variable length of the original data is generated by the silicon storage media controller according to the characteristic of the original data, and a block with a larger capacity is used as a basic access unit for managing the record space, so as to further generate a translation table and to perform the data compression/decompression operation and data access operation, such that the object of improving the data compression rate is achieved.

In order to improve the compression efficiency of the data compression/decompression operation, the data frame based silicon storage media controller mentioned above is further characterized by: the original data is compressed to reduce the storage space it occupies first, then a preceding description unit is added in front of the data which had been compressed by the controller and a post error check and correction code is added behind the compressed data, so as to form a data frame whose size is nearly equal to the storage capacity of one block. Then, an index indicator and an error check and correction code are marked in the data frame, so as to further reduce the storage space occupied by the information and to improve the effective space of the silicon storage media physically used in storing the system's valid information.

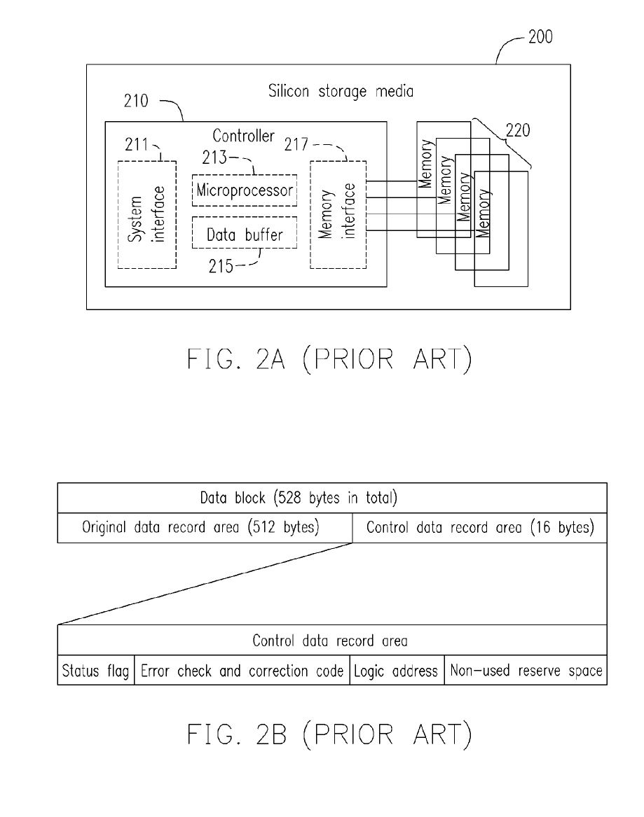

During recording the original data transmitted into the memory from the system, in additional to the original data, the controlling related information such as the data block status flag, error check and correction code, logic address, etc, should be recorded simultaneously. Referring to FIG. 2B where each bit of the controlling related information is defined, wherein:

Data block status flag: it indicates whether the status of the data stored in a block is “erased”, “in-used”, or “bad”. If it is “erased” (empty), the block can be used to record an updated data and the flag is then changed to “in-used”. If it is found that the silicon storage media for recording the data is defective and cannot be used any more to store data during the write operation, the block is then marked as “bad”. After the data stored in the block marked as “in-used” is updated and moved to another “erased” block, the block is then recovered to the “erased” status after it is erased by the erase operation.

Error check and correction code: several bytes of the error check and correction code are generated from the original data by using a specific algorithm. If it is detected that an error has occurred in the memory unit where the original data is recorded according to the error check and correction code, the error is corrected, and a correct data is then sent back to the system. When the microprocessor detects that an error has occurred in the memory unit where the original data is recorded, the correct data is moved and copied to another “erased” data block immediately, and the defective data block is marked as “bad”.

Logic address: when storing the original data into the memory, the microprocessor has to properly plan, arrange and utilize the memory in adapt with the physical addressing method suitable for the memory. Therefore, a great difference exist between the disposition sequence it uses and the logic address sequence adopted by the system to access the memory. Accordingly, it is required to install an address converting circuitry or an address converting control process inside the controller, and to generate a translation table which is used to convert the logic address provided by the system to/from the physical address used in the memory. In order to maintain such translation relation even after the power of the memory card in the system is turned off, it is required to preserve both the original data and its corresponding logic address simultaneously.

The data format of the preceding description unit in the data frame of the silicon storage media according to the present invention is described in detail hereinafter. A start address of each data frame is used to configure the start address of the data block in the storage media. In other words, for the sake of easy explanation, a first byte of the first set of pages in the blocks is configured as a start address of the data frame, and its address is configured as 0. Starting from the start address 0, the data frame is sequentially marked as the preceding description unit, the compressed data packet, and the post error check and correction code.

The content marked by the preceding description unit in the data frame should comprise the information such as the data block status flag, the original data address corresponding to the compressed data, the original data length, the optimal compression algorithm, and the parameter table. For example, a format according to an embodiment of the present invention is shown in table 1 below:

TABLE 1
Format of data frame preceding description unit

| Address | Length | Definition |
|---|---|---|
| 0 | 1 | Block status: |
| | | FF: “erased”, FO: “in-used”, OO: “bad” |
| 1 | 4 | Start address |
| 5 | 1 | Data frame length (a sector is |
| | | designated as a unit of 512 bytes) |
| 6 | 1 | Compression algorithm indicator |
| 7 | 1 | Parameter table indicator |

A compressed data packet is placed following the preceding description unit, wherein the record capacity occupied by the data packet is near to but not eceeding the size of one single block of the silicon storage media, and the length of the data packet is obtained from the fact that the capacity of the decompressed original data reaches the data length marked by the preceding description unit. The post error check and correction code is then marked after the data packet. The data format according to an embodiment of the present invention is shown in table 2 below:

TABLE 2
Format of data frame preceding description unit

| Address | Length | Definition |
|---|---|---|
| 2 | 2 | 2 bytes of checksum code |
| 2 | 2 | 2 bytes of CRC16 error check code |
| 4 | 4 | 4 bytes of reserved space used by |
| | | error check and correction code |

Wherein, after the compressed data is generated by the controller, the post error check and correction code is also generated by the controller as well. Then, the preceding description unit and the compressed data are combined to form a data frame, and the data frame is written into the block of the silicon storage media.

When the controller is performing the update or read operation, after the data frame is read, the accuracy of the data packet is verified by checking the error check code. If the verification result shows the data packet is correct, further operation is then performed. Otherwise, an error code is immediately sent back to the system, such that the system can correct its access operation by referring it.

The preceding description unit mentioned above provides following functions: (a). to indicate the data block status, for example, to indicate the status of the data block is “erased”, “in-used”, or “bad”; (b). to indicate a code of the compression algorithm used by the subsequent compressing operation; (c). to indicate a code of the parameter table suitable for the subsequent compressing operation; and (d). to indicate the index identification code of the original data address corresponding to the subsequent data and the original data length used by the controller to generate the translation table.

The compressed data is a data packet generated from the original data, and its length is varied and impacted by the compression efficiency which is a result of the original data characteristic, the compression algorithm and the parameter table it uses. In addition, a summation of the length of the compressed data and the length of the preceding description unit and the post error check and correction code forms a total size of the data frame, and its size is near to but not exceeding the size of one data block in order to fully utilize its capacity. The start address and the length of the compressed data packet obtained by compressing the original data is marked in the preceding description unit of the data frame, which are used by the controller to generate the translation table later.

The post error check and correction code is composed of the error check and correction code which is obtained by performing the error check algorithm on the compressed data. For example, the post error check and correction code is composed of a set of checksum code and a set of 16 bits Cyclic Redundancy Code (CRC16), such that the accuracy of the information stored in the compressed data packet can be verified.

The concept of using the data frame as a control unit of the digital information stored in the silicon storage media and recorded and updated by the controller is a core concept of the present invention. The core concept of the present invention is characterized by following points. 1) A data frame whose size is nearly equal to the size of one block unit of the silicon storage media is designated as a basic record and control unit, such that the controller can easily control and manage linkage relationship between individual data frames and can indicate the corresponding relationship of the original data with different address. 2). The size of individual data frame is not necessarily limited to be the size of the original data in order to adapt with the data compression rate generated by the optimal compression algorithm and parameter table for different original data. Therefore, the preceding description unit can be used to indicate the start address and the length of the original data even after the capacity of the compressed data is roughly equal to the size of one block.

Therefore, during the activation of the silicon storage media according to the present invention, the controller generates the data frame and a translation table which indicates the relationship between the data frame and the system data address according to the preceding description unit in each data frame extracted from the silicon storage media, and continuously updates and maintains an accurate translation table when it is performing further operations. During the read operation, the controller obtains the data frame according to the translation table first and then stores the data frame into an accurate position of the silicon storage media. Afterwards, the controller reads the data frame into the data buffer and decompresses the data frame, and then sends the data back to the computer system. During the write operation, the controller obtains the data frame according to the translation table first and then stores the data frame into an accurate position of the silicon storage media. Afterwards, the controller reads the data frame into the data buffer and decompresses the data frame, and the decompressed data stored in the data buffer is updated with the data written by the computer system. Then, the updated data is compressed again for rebuilding the data frame, and the compressed data frame is finally written into the silicon storage media in order to replace the original data frame.

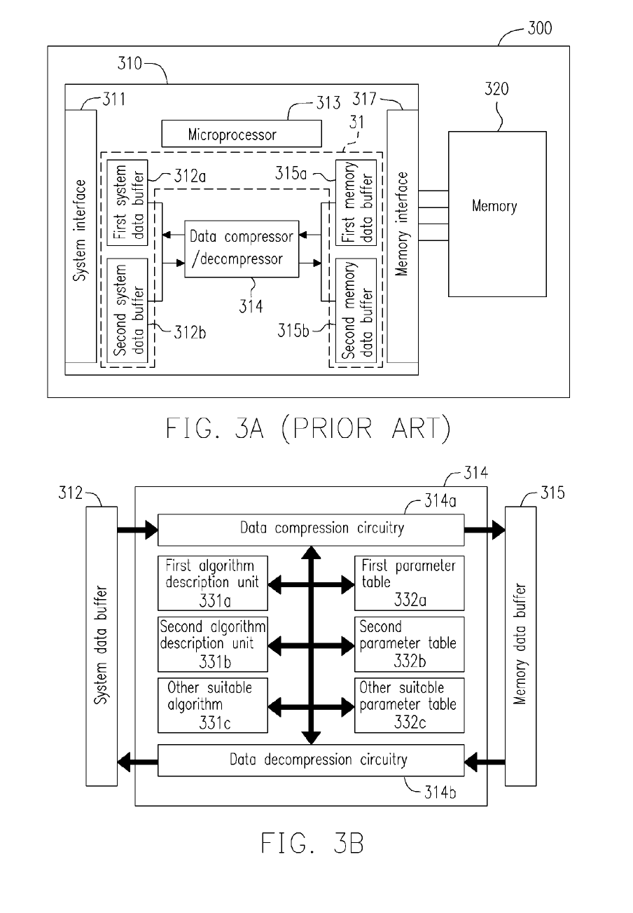

The present invention provides a configuration for a variable length data frame based silicon storage media controller. As shown in FIG. 3A, the silicon storage media 300 with data compression function comprises a controller 310; a system interface 313, which is used to provide the original data and to access a first system data buffer 312a and a second system data buffer 312b inside a buffer 31 in response to a trigger issued by a microprocessor 313; a data compression/decompression module 314, which is used to access a first memory data buffer 315a and a second memory data buffer 315b inside the buffer 31 and to work as an access interface of the memory 320 via a memory interface 317. Referring to FIG. 3B, a plurality of description units 331a, 331b, 331c of various data compression/decompression algorithms, which are used to define various data compression/decompression algorithms are further included in the data compression/decompression module 314. In addition, a plurality of various parameter tables 332a, 332b, and 332c is also included in the data compression/decompression module 314 for cooperating with the optimal algorithm. The object of installing various algorithms and parameter tables in the data compression/decompression module 314 is to select an optimal compression algorithm and to cooperate with the optimal parameter table according to the original data type. Moreover, the controller adds and marks the compression algorithm, the parameter table indicator, and the index indicator corresponding to the original data in front of the compressed data in order to generate the preceding description unit. Furthermore, the controller adds and marks the post error check and correction code behind the compressed data in order to determine whether the compressed data is accurately recorded in the storage media or not. After the data frame is generated from combining the preceding description unit, the compressed data, and the post error check and correction code, the data frame is then stored and recorded into a designated block position of the silicon storage media.

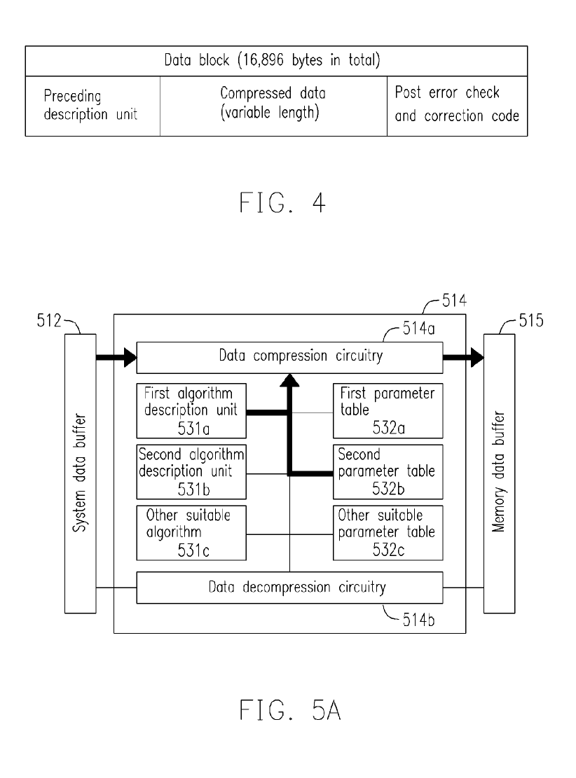

An embodiment of a 64 MB NAND type flash memory adapted to the controller of the present invention is exemplified hereinafter. When the record capacity of one block unit is 528*32=16896 bytes, the block format of the data recorded in the memory is as shown in FIG. 4. The data format includes a preceding description unit, a compressed data, and a post error check and correction code, wherein the preceding description unit is placed in front of the data block.

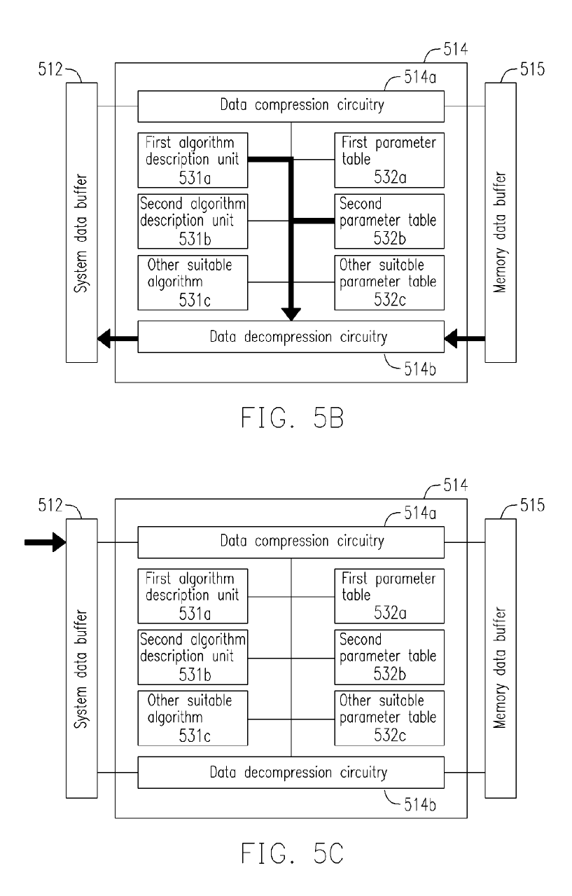

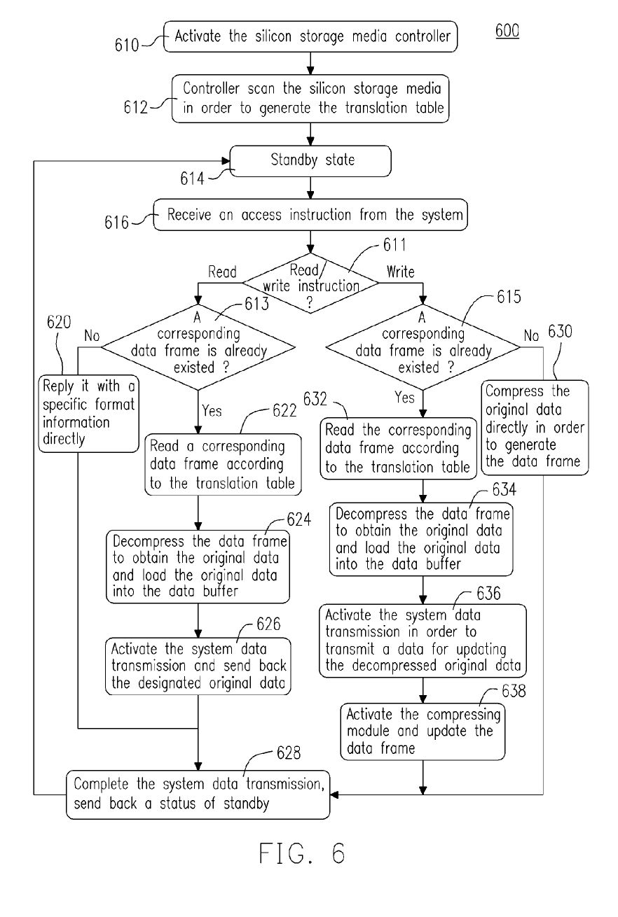

The access operation of the silicon storage media and the controller thereof according to an embodiment of the present invention is described in detail hereinafter with referring to FIG. 5A to 5C.

When System is Writing Data:

Referring to FIG. 5, if there is no existing record in the silicon storage media related to the address of the data written by the system, the original data to be written by the system is directly loaded into the system data buffer 511. Then, the data compression circuitry 514a determines an optimal algorithm according to the original data stored in the system data buffer 511. A first compression algorithm 531 a and a second parameter table 532b are selected in the present embodiment of the present invention.

Wherein, a compression register is further installed in the memory data buffer 520. When the capacity of the compressed data is nearly equal to the block size of the silicon storage media adapted to the controller, the controller adds the preceding description unit and the post error check and correction code in front of and behind the compressed data, and then writes it into the silicon storage media for completing the write operation.

When System is Updating Data:

Referring to FIG. 5B, if there is an existing record in the silicon storage media related to the address of the original data written by the system (not shown), the data frame corresponding to the address of the original data which is to be written by the system is obtained according to the mapping information described by the preceding description unit. In addition, the data frame is read from the silicon storage media and loaded into the memory data buffer 520, and it is then loaded into the system data buffer 511 after it is decompressed in order to perform the data update operation. During the decompression, the controller controls the data compression/decompression module 514b to recover the original data according to the compression algorithm 531 and the parameter table 532 indicated by the preceding description unit.

Afterwards, the controller allows the system to write in the updated data, which is then used to update the information in the system data buffer 511.

After the system data buffer is totally updated, the controller reactivates the data compression module again to compress the updated data, and the compressed data is temporarily stored in the memory data buffer 520. In the present embodiment, the first compression algorithm 531 a and the second parameter table 532b are used to compress the updated data.

The subsequent flows are the same as the flows of the write operation mentioned above, the controller adds the preceding description unit and the post error and correction code in front of and behind the compressed data for forming the data frame. After the data frame is generated, the data frame is written into an empty block of the silicon storage media, and the data original recorded in the silicon storage media is updated. Then, the data block original used for recording the non-updated data frame is erased for recovering it to the erase state.

When System is Reading Data:

Referring to FIG. 5C, when the system issues an instruction for requesting the controller to read the original data with specific address and send it back to the system, the controller immediately checks and verifies the translation table for determining whether the data frame obtained from compressing the original data corresponding to the system request is recorded in the silicon storage media or not.

If the original data corresponding to the system request is not recorded in the silicon storage media, the controller generates specific information by itself first, and then provides the information to the system.

If a specific data frame corresponding to the address of the original data which is to be accessed by the system request is recorded in the silicon storage media, the controller immediately reads the data frame from the block and loads it into the memory data buffer 520. Then, the controller activates the data decompression module to decompress the original data and then loads the decompressed data into the system data buffer 511. Afterwards, the controller reactivates the system again for sending the original data with specific address corresponding to the read request instruction issued by the system back to the system.

FIG. 6 is a flow chart for illustrating a controlling process of a silicon storage media controller according to an embodiment of the present invention. First, the silicon storage media controller is activated (S610), and the controller scans the silicon storage media and generates a translation table (S612). Then, the controller enters into a standby state (S614), and receives an access instruction from the system (S616). Then, it is determined whether the received instruction is a read instruction or a write instruction (S611) for performing further operations. If it is a read instruction, a corresponding data frame is determined (S613), and the corresponding data frame is read according to the translation table in a right sequence (S622), the data frame is decompressed and loaded into the data buffer (S624), then the system is activated to send back the designated original data (S626). If the data record does not have data frame, a special format of information is sent out directly (S620). On the other hand, if it is determined that the instruction received from the system is a write instruction and contains a data frame corresponding to the data (S615), the corresponding data frame is read according to the translation table in a right sequence (S632), then the data frame where the original data contains is decompressed and loaded into the data buffer (S634). Afterwards, the data frame of the system is activated in order to transmit a data for updating the designated original data (S636), and the compression module is activated to update the data frame (S638). If the instruction does not contain the data frame, the compression operation is directly performed in order to generate the data frame (S630). Meanwhile, regardless of the instruction is a read instruction or a write instruction, the system completes its data transmission, the status of standby is sent back (S628), and the system returns to the standby state (S614).

With the present invention, under the condition of not compressing the original data, the silicon storage capacity, whose capacity can merely store a single block data originally, can record the compressed data in a more flexible way and can indicate the original data with different length according to the characteristic of the original data and a specific data compression rate generated by the optimal compression algorithm and parameter table.

In order to have the controller smoothly track and recover the original data, and to assure the data accuracy, a preceding description unit has to add in front of the compressed data, and an error check and correction code has to add behind the compressed data, so as to form a data frame, which is then stored in the block of the silicon storage media. Wherein, the data frame is used by the controller to generate the translation table when the silicon storage media is being initialized and to read the recovered original data when the system is performing the access operation or performing the update operation.

In summary, by fully utilizing the computer power of the controller and the limited capacity of the memory, the data to be recorded in the portable storage device by the system is compressed in the controller first, and then record into the memory. Alternatively, when the system is reading the data, the compressed data is read from the memory into the controller first, and then the data is sent back to the system after it is decompressed.

Accordingly, under the premise of maintaining the same memory capacity, by adding the data compression/decompression function into the controller of the portable storage device which is made of the silicon storage media, following advantages are achieved: (a). improve the storage capacity; (b): reduce the manufacture cost; and (c): improve the data access rate.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A silicon storage media controller, suitable for a silicon storage media having a memory module and using a block as its erase unit, the silicon storage media controller comprising:
a system interface, electrically coupled to a computer system;
a memory interface, electrically coupled to the memory module;
a data buffer, electrically coupled to the system interface and the memory interface; and
a data compression/decompression module, electrically coupled to the data buffer via a bi-directional bus, for compressing/decompressing data stored in the data buffer,
wherein, data transmitted to the data buffer via the system interface by the computer system is compressed by the data compression/decompression module to a data frame whose size is complied with a storage capacity of the block.

2. The silicon storage media controller of claim 1, wherein the data buffer comprises:
a first system data buffer, electrically coupled in between the system interface and the data compression/decompression module, wherein data stored in the first system data buffer is compressed by the data compression/decompression module;
a first memory data buffer, electrically coupled in between the memory interface and the data compression/decompression module, wherein the data stored in the first memory data buffer is decompressed by the data compression/decompression module;
a second system data buffer, electrically coupled in between the system interface and the data compression/decompression module, for storing the data decompressed by the data compression/decompression module; and
a second memory data buffer, electrically coupled in between the memory interface and the data compression/decompression module, for storing the data compressed by the data compression/decompression module.

3. The silicon storage media controller of claim 1, wherein the data compression/decompression module comprises:
a data compression circuitry;
a data decompression circuitry;
at least one compression algorithm description unit, electrically coupled to the data compression circuitry and the data decompression circuitry respectively for storing a corresponding compression algorithm which is used by the data compression circuitry and the data decompression circuitry, for compressing/decompressing data; and
at least one parameter table, electrically coupled to the data compression circuitry and the data decompression circuitry respectively, for storing a plurality of parameters used by the compression algorithm,
wherein, the data compression circuitry records the compression algorithm and the parameters used by the compression operation in front of the data frame.

4. The silicon storage media controller of claim 1, wherein the silicon storage media is one of a Compact Flash Card (CF), a Memory Stick Card (MS), a Secure Digital Card (SD), and a Smart Media Card (SM).

5. A method of writing data into a silicon storage media, suitable for a silicon storage media using a block as its erase unit, the method comprising:
compressing an original data to a compressed data in a case that the original data does not exist in the silicon storage media and adding a preceding description unit including a range of the original data in front of the compressed data in order to generate a data frame, and storing the data frame into the silicon storage media; and
reading the data frame corresponding to the original data from the silicon storage media in a case that the original data exist in the silicon storage media, updating the data obtained by decompressing the data frame according to the original data and converting the updated data into a data frame format mentioned above, and storing the data frame into the silicon storage media,
wherein, one block of the silicon storage media merely serves to store a data frame.

6. The method of writing data into the silicon storage media of claim 5, wherein the data frame further comprises an error check and correction code which is placed at the end of the data frame.

7. The method of writing data into the silicon storage media of claim 5, wherein the preceding description unit further comprises an algorithm and a parameter used for compressing the original data and a status of the block where the corresponded data frame is stored.

8. The method for writing data into the silicon storage media of claim 5, wherein the range of the original data in the preceding description unit is indicated by a start address of the original data and a length of the original data.

9. A method of reading data from a silicon storage media, suitable for a silicon storage media using a block as its erase and write unit, and a block in the silicon storage media comprising a data frame, wherein the data frame comprises a preceding description unit for indicating a range of an original data which is not compressed yet, the method comprising:
reading the data frame from the silicon storage media;
decompressing the data frame according to the preceding description unit to obtain the original data; and
outputting the original data from the silicon storage media.

10. The method of reading data from the silicon storage media of claim 9, wherein the preceding description unit further comprises an algorithm and a parameter used for compressing the original data and a status of the block where the corresponded data frame is stored.

11. The method of reading data from the silicon storage media of claim 10, wherein the step of decompressing the data frame according to the preceding description unit to obtain the original data comprises:
determining the algorithm and the parameter used for compressing the original data from the preceding description unit; and
decompressing the data frame according to the algorithm and the parameter used for compressing the original data.

12. The method of reading data from the silicon storage media of claim 9, wherein the range of the original data in the preceding description unit is indicated by a start address of the original data and a length of the original data.

13. The method of reading data from the silicon storage media of claim 9, wherein the data frame further comprises an error check and correction code which is placed at the end of the data frame.

14. A silicon storage media, comprising:
a memory module, using a block as its erase and data storage unit; and
a controller, comprising:
a system interface, electrically coupled to a computer system;
a memory interface, electrically coupled to the memory module;
a data buffer, electrically coupled to the system interface and the memory interface; and
a data compressing/decompression module, electrically coupled to the data buffer via a bi-directional bus for compressing/decompressing the data stored in the data buffer,
wherein, the data transmitted to the data buffer via the system interface by the computer system is compressed by the data compression/decompression module to a data frame, and one block merely serves to store one data frame.

15. The silicon storage media of claim 14, wherein the data compression/decompression module comprises:
a data compression circuitry;
a data decompression circuitry;
at least one compression algorithm description unit, electrically coupled to the data compression circuitry and the data decompression circuitry respectively for storing a compression algorithm which is used by the data compression circuitry and the data decompression circuitry for compressing/decompressing data; and
at least one parameter table, electrically coupled to the data compression circuitry and the data decompression circuitry respectively for storing a plurality of parameters used by the compression algorithm,
wherein, the data compression circuitry records the compression algorithm and the parameters used by the compression operation in front of the data frame.

16. The silicon storage media of claim 14, wherein the silicon storage media is one of a Compact Flash Card (CF), a Memory Stick Card (MS), a Secure Digital Card (SD) and a Smart Media Card (SM).
